(19) United States
(12) Patent Application Publication
(10) Pub. No.: US 2025/0327488 A1
(43) Pub. Date: Oct. 23, 2025

(54) CONSTANT VELOCITY JOINT PROVIDED WITH GREASE RETAINER

(71) Applicant: ERAE AMS CO., LTD., Daegu (KR)

(72) Inventors: Dal Soo JANG, Daegu (KR); Jong Uk SEO, Daegu (KR)

(73) Assignee: ERAE AMS CO., LTD., Daegu (KR)

(21) Appl. No.: 18/283,260

(22) PCT Filed: Apr. 1, 2022
(86) PCT No.: PCT/KR2022/004686

§ 371 Date: Mar. 6, 2024

(30) Foreign Application Priority Data
Apr. 2, 2021 (KR) 10-2021-0043466

(51) Int. Cl. F16D 3/224; F16D 3/223

(52) U.S. Cl. CPC F16D 3/224; F16D 2003/2232; F16D 2300/06

(57) ABSTRACT

A constant velocity joint includes: an outer race provided with a through-hole extending along a longitudinal axis and forming a plurality of outer ball grooves; an inner race forming a plurality of inner ball grooves that respectively pair with the outer ball grooves; a plurality of balls that are respectively positioned within a space formed by the pair of the outer ball grooves and the internal ball grooves; a ball cage that accommodates the plurality of balls; and a grease retainer coupled to the outer race to prevent grease, which fills a space where the ball and the ball cage are placed, from leaking through the through-hole. The grease retainer has a convex shape protruding towards the ball and the ball cage.

### TECHNICAL FIELD

This invention relates to a constant velocity joint used to transmit the driving force of a vehicle, more specifically, to a constant velocity joint equipped with a grease retainer that is attached to an outer race.

### BACKGROUND ART

A constant velocity joint is a device that transmits rotational driving force and is used as a device to transmit rotational driving force by being incorporated to a drive shaft, a propeller shaft, and the like for vehicles.

A constant velocity joint like a Rzeppa joint includes an outer race, an inner race, a plurality of balls disposed between the outer and inner races, and a ball cage that accommodates the balls. In such a constant velocity joint, the outer race typically has an open side, and the balls, the ball cage, and the inner race are inserted through this open side. In such constant velocity joints, the outer race and the inner race include ball grooves respectively, and ball for transmitting torque are disposed in a space formed by the corresponding ball grooves of the outer race and the inner race.

Such constant velocity joints require lightweight and slim designs. Especially for constant velocity joints applied to a propeller shaft of a vehicle, a slim design is essential due to the high rotational speeds, aiming for weight reduction. A constant velocity joint of a slim design requires a structure that can prevent ball separation during handling processes such as assembling. To prevent the balls from being separated, a method of plastically deforming an end of the outer race through stacking has been employed, however, to realize this method, the length of the outer race becomes longer, leading to an increase in weight and additionally, the inclusion of the stacking process results in a rise in manufacturing costs.

On the other hand, the outer race needs to have the rigidity to withstand large loads generated during the torque transmission process, and as a result, the weight increases due to securing the material and thickness of the portion where the ball groove is formed. To address this issue, a method has been adopted where the part that forms the ball groove is coupled to the power transmission component through an adapter, which is formed separately. However, in this method, the outer race consists of two parts, leading to a complex structure and a complicated assembly process.

### PRIOR ART DOCUMENTS

U.S. Pat. No. 8,313,107 (2012.11.20.)

U.S. Pat. No. 9,494, 199 (2016.11.15.)

### DETAILED DESCRIPTION OF THE INVENTION

### Technical Object

The object of the present invention is to provide a constant velocity joint that is designed to effectively prevent the balls from being separated while minimizing the weight of the outer race.

### Technical Solutions

A constant velocity joint according to an embodiment of the present invention includes: an outer race provided with a through-hole extending along a longitudinal axis and forming a plurality of outer ball grooves; an inner race forming a plurality of inner ball grooves that respectively pair with the outer ball grooves; a plurality of balls that are respectively positioned within a space formed by the pair of the outer ball grooves and the internal ball grooves; a ball cage that accommodates the plurality of balls; and a grease retainer coupled to the outer race to prevent grease, which fills a space where the ball and the ball cage are placed, from leaking through the through-hole. The grease retainer has a convex shape protruding towards the ball and the ball cage.

The grease retainer may be configured to collide with one or more of the inner race and the ball cage during an articulation between the outer race and the inner race, thereby limiting rotation of the ball cage.

According to one embodiment of the prevent invention, the convex shape may include a spherical shape.

According to another embodiment of the present invention, the convex shape may include a cylindrical shape.

According to another embodiment of the present invention, the convex shape may include a cone shape or a modified cone shape.

The convex shape may include a spherical shape and a cylindrical shape that are interconnected to one another.

A constant velocity joint according to an embodiment of the present invention includes: an outer race provided with a first through-hole extending along a longitudinal axis and forming a plurality of outer ball grooves; an inner race provided with a second through-hole extending along a longitudinal axis and forming a plurality of inner ball grooves that are respectively pair with the outer ball grooves; a plurality of balls arranged respectively in a space formed by the pair of the outer ball grooves and the inner ball grooves; a ball cage that accommodates the plurality of balls; a first grease retainer coupled to the outer race to block the first through-hole in order to prevent grease filled into a space where the balls and the ball cage are placed from leaking out; and a second grease retainer coupled to the inner race to block the second through-hole in order to prevent grease filled into a space where the balls and the ball cage are placed from leaking out. The grease retainer has a convex shape protruding towards the ball and the ball cage.

The second grease retainer may be configured to collide with one or more of the inner race and the ball cage during an articulation between the outer race and the inner race, thereby limiting rotation of the ball cage.

### Effects of the Invention

According to the invention, by forming the outer race with a through hole extending along a longitudinal axis and having a grease retainer blocking this through hole that has a convex shape protruding towards the space where the ball and ball cage are placed, the amount of grease filled between the outer race and the inner race can be reduced. Also, by allowing a ball cage or an inner race to collide with the convex grease retainer during articulation, the articulation can be limited, and thus the separation of the balls can be prevented during processing without additional parts or additional processes like stacking.

### BRIEF DESCRIPTION OF DRAWINGS

FIG. 1 is a cross-sectional view of a constant velocity joint according to an embodiment of the present invention.

FIG. 2 is an exploded perspective view of a constant velocity joint according to an embodiment of the present invention.

FIG. 3 is a cross-sectional view of a state in which an outer race and an inner race of a constant velocity joint according to an embodiment of the present invention are angularly displaced with each other.

FIG. 4 is a cross-sectional view of a grease retainer of a constant velocity joint according to another embodiment of the present invention.

FIG. 5 is a cross-sectional view of a grease retainer of a constant velocity joint according to yet another embodiment of the present invention.

FIG. 6 is a cross-sectional view of a grease retainer of a constant velocity joint according to yet another embodiment of the present invention.

### EMBODIMENTS FOR CARRYING OUT THE INVENTION

Embodiments of the present invention will be described in detail with reference to the accompanying drawings below.

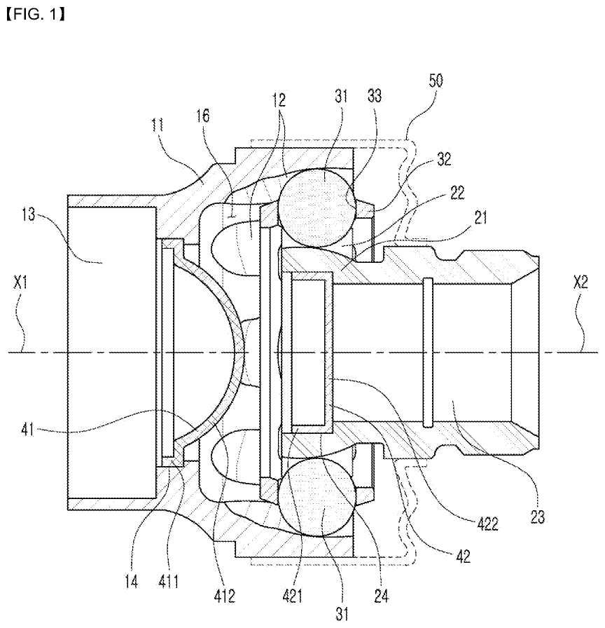

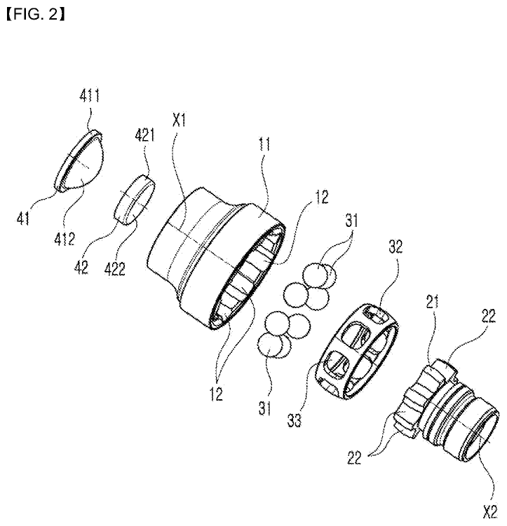

Referring to FIG. 1 to FIG. 3, a constant velocity joint includes an outer race 11 and an inner race 21 configured to be respectively connected to separate power transmission elements. A ball 31 acts as a medium for transmitting torque and is placed between the outer race 11 and the inner race 21 in a state of being accommodated in a pocket 33 of a ball cage 32. The ball 31 may be provided in a plurality, and the outer race 11 and the inner race 21 may each have outer ball grooves 12 and inner ball grooves 22 that pair up to form spaces that accommodate each ball 31. Rotational power transmission between the outer race 11 and the inner race 21 takes place through the ball 31 placed in the space formed by the outer ball grooves 12 and the inner ball grooves 22. FIG. 2 exemplarily shows a case where eight balls 31 are provided, but the number of balls 31 is not limited to this and can vary, such as six, ten, etc.

The outer race 11 forms a through-hole 13 extending along a longitudinal axis X1, and the inner race 21 can also form a through-hole 23 extending along a longitudinal axis X2. In an embodiment of a constant velocity joint according to the present invention, when installed between the differential gear and the propeller shaft, the inner race 21 can be fastened to the output shaft of the differential gear inserted into the through-hole 23 through a spline coupling, and one end (a left end in FIG. 1) of the outer race 11 can be coupled to the hollow shaft of the propeller shaft by welding.

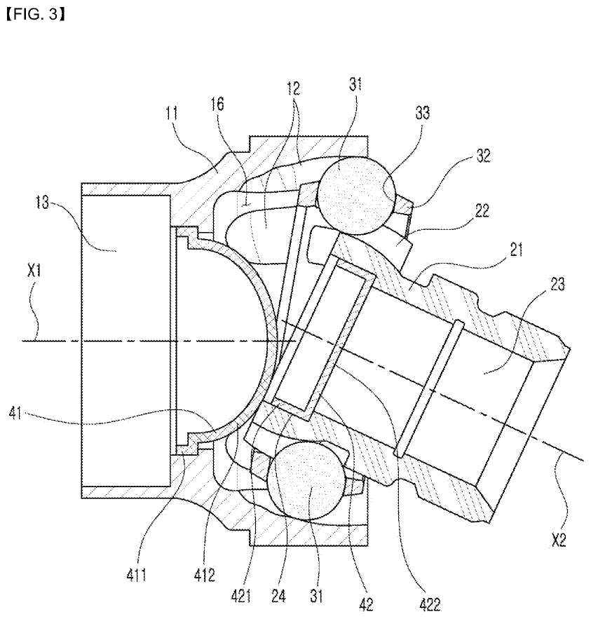

The outer race 11 and the inner race 21 may be configured to rotate for power transmission when they are angularly displaced with each other. In FIG. 1 and FIG. 3, both non-articulated states where the longitudinal axes X1 and X2 of the outer race 11 and inner race 21 are coaxial, and articulated state where they form a certain angle, are respectively shown. In an embodiment of a constant velocity joint according to the present invention, it is configured to allow the outer race 11 and the inner race 21 to rotate while being articulated within a predetermined angular range.

The space between the outer race 11 and the inner race 21 where the ball 31 and the ball cage 32 are positioned is filled with grease. Although not explicitly shown in the drawings, a boot 50 (shown as a dotted line in FIG. 1) for grease sealing between an end (a right end in FIG. 1) of the outer race 11 defining an opening and an outer peripheral surface of the inner race 21 may be provided. The boot 50 can be made of a deformable material like rubber, and one end can be fixed to the outer race 11, while the other end can be fixed to the inner race 21. Although not depicted in the drawings, both ends of the boot 50 can be fastened to the outer race 11 and the inner race 21 respectively by clamping means like a clamp.

In an embodiment of the present invention, the outer race 11 is formed as a single component for weight reduction and has the through-hole 13 formed along the longitudinal axis X1, and a grease retainer 41 is provided to seal the through-hole 13 and prevent grease leakage. The grease retainer 41 is positioned on one side of a space 16 where the ball 31 and ball cage 32 are located and is shaped to have a convex shape protruding towards the ball 31 and the ball cage 32.

The grease retainer 41 may be positioned in a seating groove 14 provided on an inner surface of the outer race 11. The grease retainer 41 may be made of metal material such as steel and may be secured in the seating groove 14 by press-fitting. As shown in FIG. 1 and FIG. 3, the grease retainer 41 may include a ring-shaped securing part 411 that is designed to be situated in the seating groove 14 of the outer race 11, and a sealing part 412 that is connected to the securing part 411 and protrudes convexly towards the space where the ball 31 and the ball cage 32 are placed. For example, the sealing part 412 can be shaped spherically. By forming the sealing part 412 of the retainer 41 to protrude convexly into the space filled with grease, the volume of the space filled with grease can be reduced, which can reduce the amount of grease introduced. A reduction in the amount of grease introduced leads to a reduction in the manufacturing cost and weight of the constant velocity joint.

Furthermore, according to an embodiment of the present invention, the grease retainer 41 coupled to the outer race 11 is configured to limit the rotational angle of the inner race 21 or the ball cage 32. When the outer race 11 and the inner race 21 are angularly displaced to each other, the inner race 21 and the ball cage 32 rotate relative to the outer race 11, and during this rotation, the inner race 23 or the ball cage 32 stops further rotating when contacting the convexly formed grease retainer 41. FIG. 3 exemplarily shows a situation where, during an articulating movement, the inner race 21 collides with the outer race 11 preventing further angulation. By ensuring that the rotation of the inner race 21 or the ball cage 32 does not articulated beyond a certain angle, the movement of the balls 31 housed in the ball cage 32 during the angulation between the outer race 11 and inner race 21 is restricted, and this restriction can prevent the balls 31 from being separated during handling process of the constant velocity joint. By utilizing the shape of the grease retainer 41 to prevent the balls 31 from being separated, the need for additional stacking processes to prevent ball separation can be eliminated and this can contribute to weight reduction and manufacturing cost savings.

Meanwhile, according to an embodiment of the present invention, a grease retainer 42 can be provided to seal a through-hole 23 that extends along a longitudinal axis X2 of the inner race 21. The grease retainer 42 may have a ring-shaped securing part 421 that can be press-fitted into the seating groove 24 formed on the inner surface of the inner race 21, and a sealing part 422 connected to the securing part 421. The grease retainer 42 may be made of metal material like steel and may be pressed into the through-hole 23 of the inner race 21.

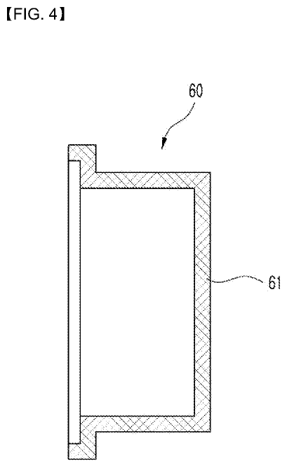

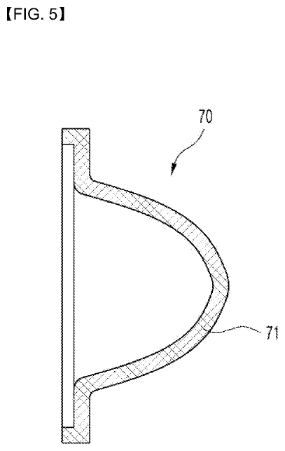

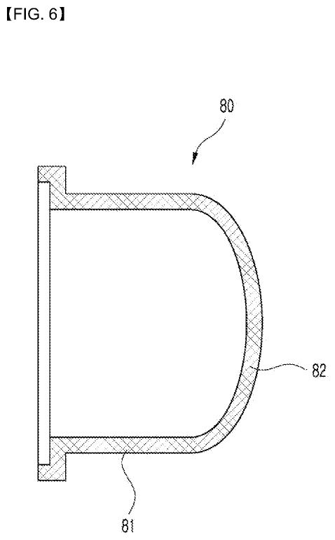

In FIG. 4 to FIG. 6, a grease retainer coupled to the outer race 11 according to another embodiment of the present invention is shown. In the embodiment shown in FIG. 4, a grease retainer 60 may have a cylindrical sealing part 61. In an embodiment shown in FIG. 5, a grease retainer 70 may be equipped with a cone or modified cone-shaped sealing part 71. The modified cone shape refers to a shape slightly altered from the cone shape, as shown in FIG. 5, where the slanted surface slightly protrudes in a convex manner. In an embodiment shown in FIG. 6, a grease retainer 80 may be equipped with a cylindrical sealing part 81 and a spherical sealing part 82 that are interconnected to one another.

Although the embodiments of the present invention have been described above, the scope of rights of the present invention is not limited thereto, and it encompasses all changes and modifications that are easily made by those skilled in the technical field to which the present invention pertains and are deemed equivalent thereto.

### INDUSTRIAL APPLICABILITY

This invention relates to a constant velocity joint that can be used in a vehicle's drive mechanism, so it has industrial applicability.

1. A constant velocity joint comprising:
an outer race provided with a through-hole extending along a longitudinal axis and forming a plurality of outer ball grooves;
an inner race forming a plurality of inner ball grooves that respectively pair with the outer ball grooves;
a plurality of balls that are respectively positioned within a space formed by the pair of the outer ball grooves and the internal ball grooves;
a ball cage that accommodates the plurality of balls; and
a grease retainer coupled to the outer race to prevent grease, which fills a space where the ball and the ball cage are placed, from leaking through the through-hole,
wherein the grease retainer has a convex shape protruding towards the ball and the ball cage.

2. The constant velocity of claim 1, wherein the grease retainer is configured to collide with one or more of the inner race and the ball cage during an articulation between the outer race and the inner race, thereby limiting rotation of the ball cage.

3. The constant velocity of claim 1, wherein the convex shape comprises a spherical shape.

4. The constant velocity of claim 1, wherein the convex shape comprises a cylindrical shape.

5. The constant velocity of claim 1, wherein the convex shape comprises a cone shape or a modified cone shape.

6. The constant velocity of claim 1, wherein the convex shape comprises a spherical shape and a cylindrical shape that are interconnected to one another.

7. A constant velocity joint comprising:
an outer race provided with a first through-hole extending along a longitudinal axis and forming a plurality of outer ball grooves;
an inner race provided with a second through-hole extending along a longitudinal axis and forming a plurality of inner ball grooves that are respectively pair with the outer ball grooves;
a plurality of balls arranged respectively in a space formed by the pair of the outer ball grooves and the inner ball grooves;
a ball cage that accommodates the plurality of balls;
a first grease retainer coupled to the outer race to block the first through-hole in order to prevent grease filled into a space where the balls and the ball cage are placed from leaking out; and
a second grease retainer coupled to the inner race to block the second through-hole in order to prevent grease filled into a space where the balls and the ball cage are placed from leaking out,
wherein the grease retainer has a convex shape protruding towards the ball and the ball cage.

8. The constant velocity joint of claim 7, wherein the second grease retainer is configured to collide with one or more of the inner race and the ball cage during an articulation between the outer race and the inner race, thereby limiting rotation of the ball cage.
